(19) United States
(12) Patent Application Publication
(10) Pub. No.: US 2025/0347833 A1
(43) Pub. Date: Nov. 13, 2025

(54) DIFFRACTIVE OPTICAL LENSES

(71) Applicant: NIL Technology ApS, Kongens Lyngby (DK)

(72) Inventors: Michael Juhl, Helsinge (DK); Villads Egede Johansen, Copenhagen (DK); Ulrich Quaade, Bagsvaerd (DK); Yuriy Elesin, Copenhagen (DK)

(21) Appl. No.: 18/862,436

(22) PCT Filed: May 3, 2023
(86) PCT No.: PCT/EP2023/061718

§ 371 Date: Nov. 1, 2024

Related U.S. Application Data
(60) Provisional application No. 63/338,535, filed on May 5, 2022.

(51) Int. Cl. G02B 5/18

(52) U.S. Cl. CPC G02B 5/1866

(57) ABSTRACT

The present disclosure describes an apparatus and system that includes a diffractive optical lens. The diffractive optical lens includes a central region shaped as a convex lens, an intermediate region laterally surrounding the central region and composed of multiple concentric zones, and an outer region laterally surrounding the intermediate region. A respective outer radius rₕ of each of the concentric zones in the intermediate region is (Eq. 1), where λ₀ is an operating wavelength of the diffractive optical lens, f is a focal length of the diffractive optical lens, and h is an integer. At least one of the zones in the intermediate region includes at least one of (i) a continuous annular trough or (ii) a plurality of isolated holes that collectively encircle the central region.

### FIELD OF THE DISCLOSURE

The present disclosure relates to diffractive optical elements (DOEs) such as lenses.

### BACKGROUND

A Fresnel lens is a type of composite compact lens in which the curved surface of a conventional optical lens is replaced with flat segments or a series of sawtooth-shaped concentric protrusions. Each protrusion can be at a slightly different angle and size than the next and with the same focal length in order to focus the light toward a central focal point. The contours can act as individual refracting surfaces that bend parallel light rays to a common focal length. The relatively thin, lightweight construction, availability in small as well as large sizes, and excellent light gathering ability can make Fresnel lenses useful in a variety of applications, including light gathering applications (e.g., condenser systems or emitter/detector arrangements). They also can be used as magnifiers or projection lenses in illumination systems and image formulation systems. However, due to the presence of the saw-tooth shaped concentric protrusions, a focusing Fresnel lens has discontinuities at the boundaries between adjacent zones, which tend to cause light scattering and shadowing, which can reduce the focusing efficiency of the lens.

### SUMMARY

The present disclosure describes diffractive optical elements (DOEs) such as lenses. For example, in one aspect, the present disclosure describes an apparatus that includes a diffractive optical lens. The diffractive optical lens includes a central region shaped as a convex lens, an intermediate region laterally surrounding the central region and composed of multiple concentric zones, and an outer region laterally surrounding the intermediate region. A respective outer radius rₕ of each of the concentric zones in the intermediate region is rₕ=[(f++λ₀)²−f²]^{1/2}, where λ₀ is an operating wavelength of the diffractive optical lens, f is a focal length of the diffractive optical lens, and h is an integer. At least one of the zones in the intermediate region includes at least one of (i) a continuous annular trough or (ii) a plurality of isolated holes that collectively encircle the central region.

Some implementations include one or more of the following features. For example, in in some instances, each of the zones in the intermediate region includes a respective continuous annular trough. In some implementations, each of the respective continuous annular troughs is located at a respective radial position and has a respective depth that increases optical efficiency of the diffractive optical lens. In some cases, each particular one of the zones in the intermediate region further includes at least one annular indentation in a same surface as the continuous annular trough in that zone. In some instances, the at least one annular indentation includes a plurality of indentations in a staircase configuration.

In some instances, each of the zones in the intermediate region includes a respective plurality of isolated holes that collectively encircle the central region. The plurality of isolated holes in each respective one of the intermediate zones can be located, for example, at a radial position such that the holes in the respective intermediate zone collectively increase optical efficiency of the diffractive optical lens. In some instances, each particular one of the zones in the intermediate region further includes at least one annular indentation in a same surface as the plurality of isolated holes in that zone. In some instances, the annular indentation(s) can include, for example, a plurality of indentations in a staircase configuration.

In some implementations, the outer region is a non-Fresnel-like region.

The present disclosure also describes an apparatus including an optical sensor, an aperture, and a diffractive optical lens disposed between the sensor and the aperture. The diffractive optical lens includes a central region shaped as a convex lens, an intermediate region laterally surrounding the central region and composed of multiple concentric zones, and an outer region laterally surrounding the intermediate region. A respective outer radius rₕ of each of the concentric zones in the intermediate region is rₕ=[(f+hλ₀)²−f²]^{1/2}, where λ₀ is an operating wavelength of the diffractive optical lens, f is a focal length of the diffractive optical lens, and h is an integer. Each of the zones in the intermediate region includes at least one of (i) a continuous annular trough or (ii) a plurality of isolated holes that collectively encircle the central region.

Other aspects, features and advantages will be readily apparent from the following detailed description, the accompanying drawings and the claims.

### BRIEF DESCRIPTION OF THE DRAWINGS

FIG. 1A is a cross-section of an example of a Fresnel lens.

FIG. 1B is a perspective view of the Fresnel lens of FIG. 1A.

FIG. 2 illustrates an example of the structure of a diffractive optical lens in accordance with an implementation of the present disclosure.

FIG. 3 is a flow chart of a machine-implemented algorithm for designing a diffractive optical lens in accordance with an implementation of the present disclosure.

FIG. 4 illustrates a further example of the structure of intermediate zones of a diffractive optical lens in accordance some implementations of the present disclosure.

FIG. 5 illustrates an example of a module that includes a diffractive optical lens in accordance with the present disclosure.

FIG. 6 illustrates another example of a module that includes a diffractive optical lens in accordance with the present disclosure

### DETAILED DESCRIPTION

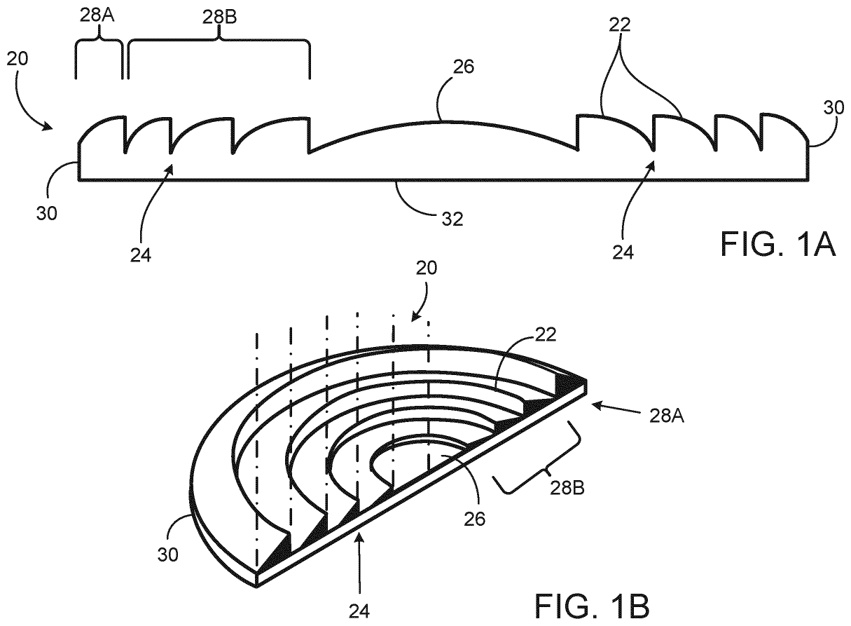

As illustrated in FIGS. 1A-1B, a Fresnel lens 20 can include a series of sawtooth-shaped concentric annular protrusions 22. That is, the continuous surface of a standard lens effectively is divided into a set of surfaces of the same curvature, with stepwise discontinuities 24 between them. Each protrusion 22 can be at a slightly different angle than the next and with the same focal length in order to focus the light toward a central focal point. In some cases, each protrusion 22 may be substantially continuous (i.e., smooth), whereas in other cases, each protrusion may be formed as a series of binary or multi-level steps.

The lens 20 has a center zone 26, which may be shaped as a conventional normal convex lens, and a series of concentric zones 28 from the lens center to the edge 30 of the lens 20. The zones 28 include an outer zone 28A that is closest to the lens edge 30, and one or more intermediate zones 28B that are disposed between the center zone 26 and the outer zone 28A. The side of the lens 20 opposite the protrusions 22 can have a substantially flat surface 32.

The Fresnel zone radii, rₕ, are defined such that rays emanating from adjacent zones add constructively at the focal point. This means that the adjacent ray paths differ by λ₀, the design or operating wavelength of the lens. The outer radius of the h-th Fresnel zone can be computed as:

$${r}_{h} = {[ {( f + h {λ}_{0} )}^{2} - {f}^{2} ]}^{1 / 2} \qquad ( Eq . 1 )$$

where λ₀ is the design or operating wavelength of the lens, f is the focal length of the lens, and h is an integer.

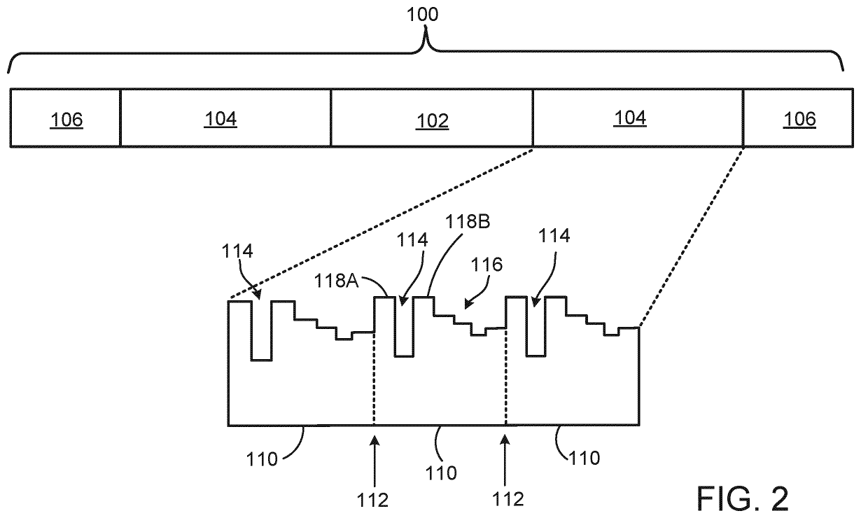

As noted above, the presence of the discontinuities 24 between adjacent zones 28 in the Fresnel lens 20 can lead to light scattering and shadowing. To help reduce such optical scattering and/or shadowing, a respective trough (e.g., a groove) can be introduced into one or more of the intermediate zones. As illustrated in FIG. 2, a diffractive optical lens 100 includes a central region 102, an intermediate region 104 and an outer region 106. The central region 102 can be a Fresnel-like region that is dominated by refraction. The central region 102 may be shaped as a conventional normal convex lens and may have a substantially smooth surface. The central region 102 is surrounded laterally by the intermediate region 104, which can be a Fresnel-like region 104 composed of multiple intermediate concentric zones 110. Adjacent zones 110 are separated from one another by a respective discontinuity 112, where the outer radius rₕ of each zone can be determined using equation (1) above. That is, assuming for example that the input to the optimizer is a Fresnel lens, the location of each zone, relative to the lens center, is the same as for a Fresnel lens designed to implement substantially the same phase function at the same operating wavelength. The intermediate region 104 is surrounded laterally by an outer non-Fresnel-like region 106 composed of one or more concentric zones. The outer region 106 may be composed, for example, of zones that present a semi-periodic structure on top of an underlying semi-periodic structure.

As further shown in FIG. 2, each of the intermediate concentric zones 110 includes a respective annular trough 114. The location and depth of the respective trough 114 within each zone 110 can be chosen to reduce at least one of light scattering or shadowing that otherwise would be introduced by an adjacent discontinuity 112. That is, the troughs 114 are provided to improve the optical efficiency of the lens structure so that a greater percentage of light passing through the lens (i.e., passing through the structured surface and through the planar surface) is focused onto the focal point of the lens.

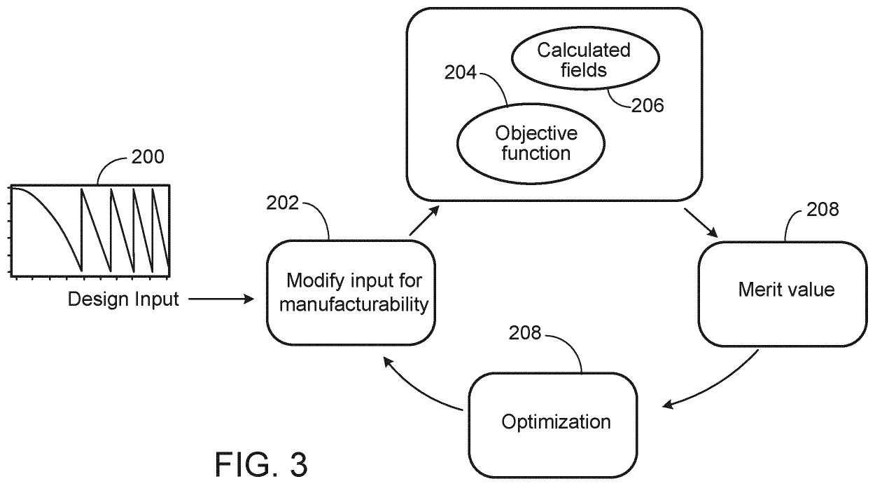

A machine (e.g., computer) implemented simulation algorithm can be used, for example, to determine the structure of each zone in the lens, including the location and depth of the respective trough 114 in each intermediate zone 110. In some implementations, a conventional Fresnel lens structure, based on the desired phase function, is provided as an initial input 200 to the simulation algorithm. The initial input may be based on an analytical design for the lens structure, which then is modified to make the design manufacturable (see 202 in FIG. 3). For example, a lens structure based on an analytical design may be modified to provide a lens structure that has discrete etch levels. The algorithm can use an objective function 204 to calculate a merit value 208 based on the resulting optical fields 206 of light passing through the lens. For example, in some instances, the merit value may be the optical (e.g., focusing) efficiency of the lens structure. That is, the algorithm may calculate what percentage of an optical signal passing through the structure would be focused onto the focal point of the lens. The algorithm then repeatedly cycles through the foregoing operations, including changing the location and/or depth of the trough in one or more of the zones in the intermediate region 104, in an attempt to optimize and stabilize the merit value (e.g., the optical efficiency of the lens structure) while maintaining the overall phase function (see 210). In some instances, the optimization may involve repeatedly performing the foregoing operations up to a maximum number of times to identify the structure that achieves the highest optical efficiency. In some instances, the optimization may involve repeatedly performing the foregoing operations until a predetermined optical efficiency is achieved.

As indicated by FIG. 2, each trough 114 can be disposed between a respective pair of plateaus 118A, 118B. The plateaus 118A, 118B may be at the same height, or different heights, above the flat surface of the lens. In some instances, the depth of a trough 114 may be as large as the operating wavelength λ₀. In some instances, the width of each trough 114 is on the order of 400 nm or less for an operating wavelength λ₀ of 940 nm. Other values may be appropriate for some implementations and may depend, among other things, on the wavelength dependency of the refractive index. Lithography and/or the maximum attainable aspect ratio may place constraints on the depth and/or width of the troughs 114. Although FIG. 2 shows the troughs 114 as having near vertical sidewalls, in some implementations, the troughs 114 may have curved, sloped or rounded sidewalls. In some cases, troughs 114 in intermediate zones 110 closer to the center region 102 are thinner and/or shallower than troughs 114 in zones 110 further from the center region 102.

The algorithm can be implemented, for example, in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., C, SQL, or Java), including compiled or interpreted languages, and it can be deployed in any form, including as a stand-alone program or as a module, component, subroutine, a browser-based web application, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

As further shown in FIG. 2, in some instances, one or more of the intermediate zones 110 also may include one or more shallow annular indentations 116 in the structured surface of the lens 100. In some cases, as shown in FIG. 2, the indentations 116 in a particular zone 110 have a staircase configuration. In some instances, the indentations 116 serve as an anti-reflection filter. The indentations 116 may be disposed, for example, closer to the outer boundary of the particular zone 110 than is the trough 114 in that zone.

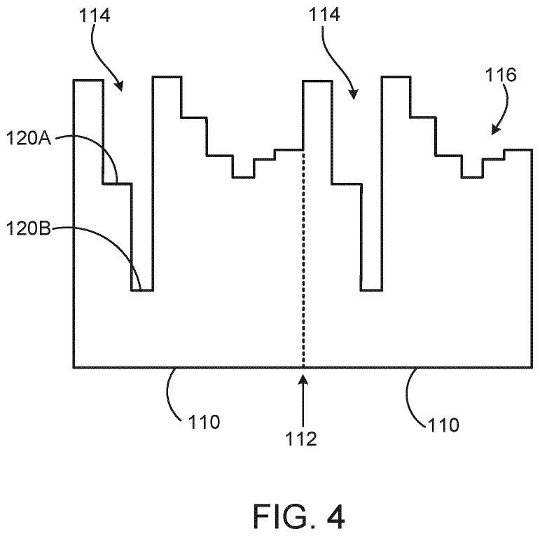

In some implementations, the bottom of the trough 114 in a particular zone 110 may not be flat. For example, as shown in FIG. 4, one or more of the troughs 114 may include multiple dips 120A, 120B at different heights, and in some instances, may have a staircase shape.

Instead of a continuous trough (e.g., in the shape of a ring), some implementations use a series of isolated holes that collectively circumscribe (i.e., encircle) the center region 102. That is, the isolated holes lie along a ring that encircles the center region 102 and are disposed so as collectively to reduce at least one of light scattering or shadowing that otherwise would be introduced by an adjacent discontinuity 112 at the boundary between zones 110 in the lens structure.

Diffractive optical elements in accordance with the foregoing design can be manufactured, for example, by providing a layer of replication material on a glass or other substrate, and then replicating the structured surface for the lens in the layer of replication material. In general, replication refers to a technique by means of which a given structure is reproduced, e.g., etching, embossing or molding. In an example of a replication process, a structured surface is embossed into a liquid or plastically deformable material (a “replication material”), then the material is hardened, e.g., by curing using ultraviolet (UV) radiation or heating, and then the structured surface is removed. Thus, a negative of the structured surface (a replica) is obtained. The replication material can include, for example, a polymer, a spin-on-glass, or any other material that may be structured in a replication process. Suitable materials for replication include, for example, hardenable (e.g., curable) polymer materials or other materials which are transformable in a hardening or solidification step (e.g., a curing step) from a liquid or plastically deformable state into a solid state. For example, in some implementations the replication material is a UV-curable, microwave-curable, and/or thermally-curable epoxy or resin (e.g., a photoresist). In some implementations, the replication material 104 is transparent to visible and/or infrared light before and/or after curing.

In other implementations, the structured surface for the lens can be etched into a substrate that is transparent to the operating wavelength. In some instances, the substrate is composed, for example, of glass or silicon.

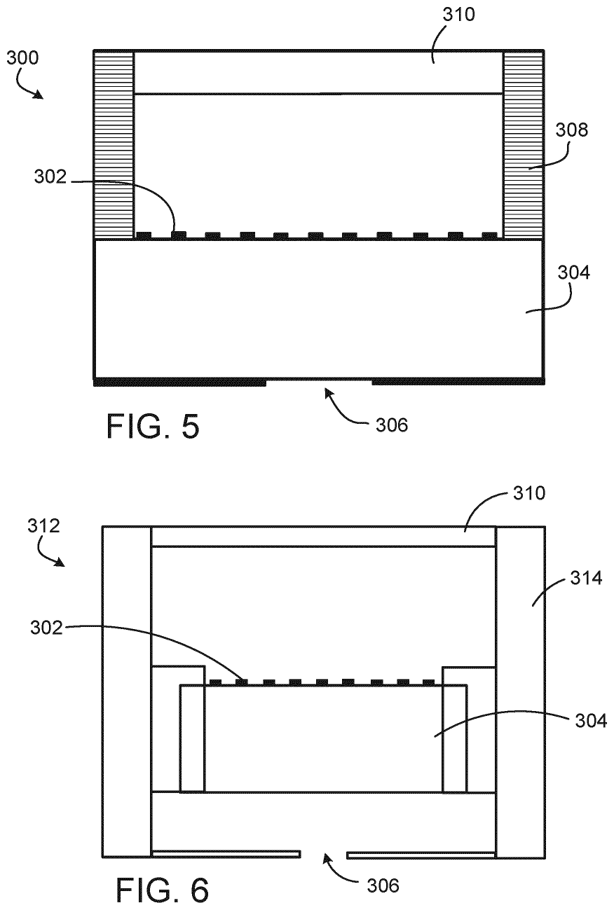

In some implementations, DOEs as described in this disclosures can be integrated, for example, into optical or optoelectronic modules. As shown in the example of FIG. 5, an optical module 300 includes a wafer level mount in which the DOE lens 302 is on a first (e.g., upper) side of a wafer 304, and an aperture 306 is on a second, opposite (e.g., bottom) side of the wafer. In the illustrated example, a spacer 308 holds an optical sensor 310. The distance between the lens 302 and the aperture 306 should be substantially the same as the distance between the lens 302 and the sensor 310. If the focal distance is larger than the available wafer, the lens 302 can be placed, for example, in a barrel 314 having an aperture 306, as shown in the example module 312 of FIG. 6. Alternatively, in some implementations, a spacer can extend through to the other side. In some implementations, the wafer can be diced and placed in a container, which then can be mounted in a barrel. The focal distance can be adjusted, as needed. The lens 302 in FIGS. 5 and 6 can be implemented, for example, as the lens 100 described above.

The modules described above may be integrated, for example, in mobile phones, laptops, television, wearable devices, or automotive vehicles.

While this document contains many specific implementation details, these should not be construed as limitations on the scope of any inventions or of what may be claimed, but rather as descriptions of features specific to particular embodiments. Certain features that are described in this document in the context of separate embodiments can also can be implemented in combination in a single embodiment. Conversely, various features that are described in the context of a single embodiment can also can be implemented in multiple embodiments separately or in any suitable sub-combination. Various modifications can be made to the foregoing examples. Accordingly, other implementations also are within the scope of the claims.

1. An apparatus comprising:
a diffractive optical lens comprising:
a central region shaped as a convex lens;
an intermediate region laterally surrounding the central region and composed of multiple concentric zones; and
an outer region laterally surrounding the intermediate region,
wherein a respective outer radius m of each of the concentric zones in the intermediate region is
$${r}_{h} = {[ {( f + h {λ}_{0} )}^{2} - {f}^{2} ]}^{1 / 2}$$
where λ₀ is an operating wavelength of the diffractive optical lens, f is a focal length of the diffractive optical lens, and h is an integer, and
wherein at least one of the zones in the intermediate region includes at least one of (i) a continuous annular trough or (ii) a plurality of isolated holes that collectively encircle the central region.

2. The apparatus of claim 1 wherein each of the zones in the intermediate region includes a respective continuous annular trough.

3. The apparatus of claim 2 wherein each of the respective continuous annular troughs is located at a respective radial position and has a respective depth that increases optical efficiency of the diffractive optical lens.

4. The apparatus of claim 2, wherein each particular one of the zones in the intermediate region further includes at least one annular indentation in a same surface as the continuous annular trough in that zone.

5. The apparatus of claim 4 wherein the at least one annular indentation includes a plurality of indentations in a staircase configuration.

6. The apparatus of claim 1 wherein each of the zones in the intermediate region includes a respective plurality of isolated holes that collectively encircle the central region.

7. The apparatus of claim 6 wherein the plurality of isolated holes in each respective one of the intermediate zones is located at a radial position such that the holes in the respective intermediate zone collectively increase optical efficiency of the diffractive optical lens.

8. The apparatus of claim 6, wherein each particular one of the zones in the intermediate region further includes at least one annular indentation in a same surface as the plurality of isolated holes in that zone.

9. The apparatus of claim 8 wherein the at least one annular indentation includes a plurality of indentations in a staircase configuration.

10. The apparatus of claim 1, wherein the outer region is a non-Fresnel-like region.

11. An apparatus comprising:
an optical sensor;
an aperture;
a diffractive optical lens disposed between the sensor and the aperture, wherein the diffractive optical lens includes:
a central region shaped as a convex lens;
an intermediate region laterally surrounding the central region and composed of multiple concentric zones; and
an outer region laterally surrounding the intermediate region,
wherein a respective outer radius m of each of the concentric zones in the intermediate region is
$${r}_{h} = {[ {( f + h {λ}_{0} )}^{2} - {f}^{2} ]}^{1 / 2}$$
where λ₀ is an operating wavelength of the diffractive optical lens, f is a focal length of the diffractive optical lens, and h is an integer, and
wherein each of the zones in the intermediate region includes at least one of (i) a continuous annular trough or (ii) a plurality of isolated holes that collectively encircle the central region.
